(19) United States
(12) Patent Application Publication
(10) Pub. No.: US 2006/0024531 A1
(43) Pub. Date: Feb. 2, 2006

(54) Magnetic recording medium and method for manufacturing same, and method for recording and reproducing with magnetic recording medium

(75) Inventor: Motoyoshi Murakami, Hirakata-city (JP)

Correspondence Address: WENDEROTH, LIND & PONACK, L.L.P., 2033 K STREET N. W., SUITE 800, WASHINGTON, DC, 20006-1021, US

(73) Assignee: Matsushita Electric Industrial Co., Ltd.

(21) Appl. No.: 11/188,884

(22) Filed: Jul. 26, 2005

(30) Foreign Application Priority Data
Jul. 27, 2004 (JP) 2004-218157

(51) Int. Cl. B05D 5/12; G11B 5/66

(52) U.S. Cl. 428/827; 427/128

(57) ABSTRACT

A magnetic recording medium is disclosed which eliminates the difficulty of stably forming tiny recording magnetic domains during high density recording. The magnetic recording medium is constituted such that at least a recording layer is provided on a disk substrate, and the recording layer is bonded with hydrogen and is in a localized and stable state of coupling with a rare earth metal, as well as a method for manufacturing this medium. As a result, the magnetic anisotropy of the recording layer is increased and a stable film structure can be formed, which stabilizes the recording magnetic domains even when the mark length is reduced, and greatly increases recording density without reducing the reproduction signal amplitude.

### FIELD OF THE INVENTION

The present invention relates to a rewritable magnetic recording medium, and more specifically a magnetic recording medium with which signals are recorded and reproduced while the temperature is raised by light that is incident on the recording medium, as well as to a method for manufacturing this medium, and to a method for recording and reproducing with this medium.

### BACKGROUND OF THE INVENTION

Optical recording media, such as magneto-optical recording media or phase change recording media, are portable recording media that allow large amounts of data to be recorded at high density, and the growth of multimedia applications in recent years has been accompanied by rapidly increasing demand for media capable of recording large computer files or video files.

Optical recording media generally consist of a multilayer film including a recording layer formed on a plastic or other transparent, disk-shaped substrate. Information is recorded to or deleted from these optical recording media by irradiating the medium with a laser using a focus servo and using a tracking servo while using guide grooves or pre-pits, and signals are reproduced by using the reflected laser light.

The most common type of magnetic recording medium used to involve so-called light modulation recording, in which erasure was performed by adding a stationary magnetic field, after which recording was performed by adding a stationary magnetic field in the opposite direction. However, a magnetic field modulation approach, in which laser light is applied while the magnetic field is modulated according to a recording pattern, have also been attracting attention as a method that allows recording in a single rotation (direct overwrite) and also affords accurate recording even at high recording densities at high speed. Phase change recording media has been put in to practical use because direct overwriting is possible with light modulation recording, and reproduction is possible with the same optical system as with a CD or DVD.

The limit to recording density with an optical recording medium is a function of the diffraction limit (≈λ/2 NA; where NA is the numeric aperture of the objective lens) determined by the laser wavelength (λ) of the light source. More recently, a system has been proposed in which an NA of 0.8 or higher is obtained by using a pair of objective lenses, and much development has gone into this system. The laser used for recording and reproduction has conventionally irradiated the recording film through the substrate, but the larger is the NA, the greater is the astigmatism produced by substrate tilt as the light passes through the substrate, for example, so the substrate must be made thin.

In addition, higher recording density has been achieved with magnetic recording media than with optical recording media as a result of improvements to the medium and the development of practical GMR heads, TMR heads and so forth. However, for even higher densities to be attained with magnetic recording media, it is essential that there be improvement to techniques for increasing the density on a recording film, to improvement on heat-stability and to disk head interface technology.

Furthermore, with an magneto-optical recording medium, there has been a proposal for a technique in which the apparent reproduction signal is increased by domain wall movement (see Japanese Laid-Open Patent Application Publication H6-290496, for example), but there were problems in terms of recording at higher density on a recording film.

Furthermore, in the case of magnetic recording, smaller recording domains and higher density have made the thermal stability of the recording magnetic domain a matter of great import, so the stability of the recording magnetic domain, and reliability as an information storage medium must be ensured.

However, when density was increased with the conventional magnetic recording media discussed above, magnetic anisotropy had to be increased because of the problem with thermal stability in the recording magnetic domain.

A characteristic of FePt-based magnetic materials is their high magnetic anisotropy, but the material had to be annealed at high temperature in order to achieve a uniform crystal orientation.

Meanwhile, rare earth metal-transition metal-based materials are amorphous, so movement of the magnetic domain wall resulted in instability and disappearance of the magnetic domain of the tiny recording marks.

Furthermore, regardless of the method, the problems are that it is difficult to ensure sufficient long-term reliability for an information storage medium, and stability is poor in high density recording as a result of smaller recording marks.

It is an object of the present invention to provide a magnetic recording medium with excellent signal characteristics, which ensures good stability of recorded information, even when it is recorded at high density, in a recording medium that performs magnetic recording and reproduction.

It is another object of the present invention to provide a magnetic recording medium with excellent signal characteristics, which improves stability of tiny recording marks, even with a recording medium that performs magnetic recording and reproduction while the temperature of the recording film is raised by optical irradiation.

This invention addresses these objects as well as other objects, which will become apparent to those skilled in the art from this disclosure.

### SUMMARY OF THE INVENTION

The inventors perfected the present invention as follows as a result of diligent study in light of the above situation.

Specifically, the magnetic recording medium of the present invention is a magnetic recording medium comprising a recording film that includes at least a recording layer having magnetic anisotropy in the direction perpendicular to the film plane on a disk substrate, wherein at least the recording layer contains elemental hydrogen in the film. The result of the recording layer thus taking up elemental hydrogen is the stabilization of the fine structure of the recording layer. More specifically, even when recording at high density, it is possible to form a recording layer with which the tiny magnetic domains can be recorded stably, and as a result, excellent signal characteristics are obtained.

Alternatively, the present invention provides a magnetic recording medium comprising a recording film that includes at least a recording layer having magnetic anisotropy in the direction perpendicular to the film plane on a disk substrate, wherein the recording layer contains a hydrogen compound. The result of the recording layer thus taking up a hydrogen compound is the stabilization of the fine structure of the recording layer. More specifically, even when recording at high density, it is possible to form a recording layer with which the tiny magnetic domains can be recorded stably, and as a result, excellent signal characteristics are obtained.

It is preferable if the hydrogen uptake is localized in the recording layer. The phrase “localized hydrogen uptake” means a state in which a state of bonding with a specific element forms a strong film structure, rather than the elemental hydrogen being uniformly dispersed in the recording layer.

Alternatively, it is preferable for the elemental hydrogen taken up in the recording layer to be in a bonded state with a thermal desorption spectrometry (TDS) temperature of at least 500° C.

It is preferable if the recording film contains a rare earth metal, and if the hydrogen in the recording film is in a state of localized bonding with the rare earth metal in the recording film. This results in stronger bonding between the elemental hydrogen and the rare earth metal and in removal of oxygen. Consequently, the film structure is stable, and a highly reliable recording film can be realized even when a recording domain is formed at high recording density. It is preferable if the rare earth metal is at least one selected from among Tb, Gd, Dy, Nd, Ho, Pr, and Er.

It is preferable if the recording layer forms a columnar structure.

It is preferable if the recording layer forms a superlattice-like laminar structure.

It is preferable if the hydrogen atom uptake of the recording layer is at least 0.2 at %.

It is preferable if the recording film is made up of a plurality of layers, and the hydrogen content in the recording layer is the greatest out of the plurality of layers.

It is preferable if the thickness of the recording layer is at least 20 nm and no more than 400 nm.

It is preferable if the recording film includes an intermediate layer, and the thickness of the intermediate layer is at least 5 nm.

The present invention also provides a method for manufacturing a magnetic recording medium in which at least a recording layer having magnetic anisotropy in the direction perpendicular to the film plane is formed on a disk substrate, wherein the recording layer is grown using a vacuum atmosphere in which the ultimate vacuum in a vacuum processing chamber at least prior to the formation of the recording layer is no higher than 5×10⁻⁵ Pa, and the hydrogen gas partial pressure in a vacuum evacuated state is at least 1×10⁻⁸ Pa.

It is preferable if the hydrogen partial pressure in the vacuum processing chamber is at least 10 times the nitrogen partial pressure.

The present invention also provides a method for manufacturing a magnetic recording medium in which at least a recording layer having magnetic anisotropy in the direction perpendicular to the film plane is formed on a disk substrate, wherein the recording layer is grown as a film in an atmosphere containing hydrogen at least during the formation of the recording layer.

It is preferable if the hydrogen partial pressure is between 0.2% and 20% with respect to a sputtering gas containing neon, argon, krypton, or xenon. In particular, when a sputtering gas such as krypton or xenon is used, it is easier to produce a fine structure in the recording film because the molecular weight is lower than that of argon, neon, or the like. Accordingly, the elemental hydrogen uptake tends to be better, and the effect is even better in terms of stabilizing the recording film. If the sputtering here is performed at a high energy level and at a low sputtering pressure, there will be less uptake of gases other than elemental hydrogen, such as oxygen and nitrogen, especially coming from degasification. As a result, the recording film and the elemental hydrogen will be bonded more tightly, forming a more stable recording film.

It is preferable if the deposition rate during the formation of a base layer that serves as a base for the recording layer is lower than the deposition rate during the formation of the recording layer.

It is preferable if the recording layer is formed at a film deposition rate of at least 2 nm/sec and no higher than 20 nm/sec.

The present invention also relates to a method for manufacturing a magnetic recording medium in which at least a recording layer having magnetic anisotropy in the direction perpendicular to the film plane is formed on a disk substrate, wherein the magnetic recording medium is held in an atmosphere containing hydrogen at least after the formation of the recording layer.

It is preferable if the magnetic recording medium is held in a vacuum atmosphere containing argon, and the hydrogen partial pressure with respect to the argon in the vacuum atmosphere is at least 5%.

It is preferable if the magnetic recording medium is held in an atmosphere that contains hydrogen and has been pressurized to at least 1 atm.

It is preferable if the magnetic recording medium is held in an atmosphere in which the hydrogen partial pressure with respect to nitrogen is at least 10%.

The present invention also relates to a method for manufacturing a magnetic recording medium in which at least a recording layer having magnetic anisotropy in the direction perpendicular to the film plane is formed on a disk substrate, wherein ion irradiation etching, plasma etching, or another type of dry etching is performed in an atmosphere containing hydrogen gas at least after the formation of the recording layer.

It is preferable if the hydrogen partial pressure is between 0.2% and 20% with respect to a sputtering gas containing neon, argon, krypton, or xenon.

The present invention also relates to a method for recording and reproducing with a magnetic recording medium, wherein information signals on a disk are recorded and reproduced while the temperature of a recording layer containing hydrogen is raised by directing a laser spot at a magnetic recording medium.

The magnetic recording medium of the present invention is not limited to the constitutions discussed above, and is not particularly limited to the details given above, as long as the constitution is one that makes use of differences in magnetic characteristics in regions of different surface characteristics in order to form servo signals or reference signals for a servo, or a method for manufacturing this constitution, or a recording and reproduction method involving the same.

With a magnetic recording medium comprising at least a recording layer having magnetic anisotropy in the direction perpendicular to the film plane on a disk substrate, if the recording layer has a microstructure that is stabilized by bonding with hydrogen, fine recording magnetic domains can be recorded more stably. Put another way, it will be possible to greatly increase recording density without adversely affecting the reproduction signal amplitude.

In addition, with a recording medium that performs magnetic recording and reproduction while the temperature of a recording film is raised by irradiation with light, reliability can be enhanced by stabilizing servo characteristics, disk productivity can be boosted, and cost can be greatly lowered.

Furthermore, it is possible to provide a magnetic recording medium with which stable recording and reproduction characteristics are obtained and signal characteristics are excellent, even when rewriting is repeatedly performed in high density recording, as well as a method for manufacturing this medium, and a recording and reproduction method.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a cross section of the constitution of the magnetic recording medium in Embodiment 1 of the present invention;

FIG. 2a is the TDS (thermal desorption spectrometry) profile of release elements of the magnetic recording medium in an embodiment of the present invention versus the thermal desorption temperature, and FIG. 2b is the TDS (thermal desorption spectrometry) profile of release elements of a conventional magnetic recording medium versus the thermal desorption temperature;

FIG. 3 is an SEM micrograph of a cross section of a magnetic recording medium in an embodiment of the present invention;

FIG. 4 is a diagram of the structure of the apparatus used to manufacture the magnetic recording medium in an embodiment of the present invention;

FIG. 5 is a cross section of the structure of the magnetic recording medium in Embodiment 2 of the present invention;

FIG. 6 is a characteristics of the dependence of the signal quantity on the recording mark length in the case of FIGS. 2a and 2b;

FIG. 7 is a characteristics of the dependence of the limit mark length on the elemental hydrogen content;

FIG. 8 is a characteristics of the change in magnetic anisotropy versus the sputtering pressure using argon or xenon;

FIG. 9 consists of a cross section and graphs of a magnetic recording medium, used for describing the reproduction operation with the magnetic recording medium in an embodiment of the present invention, with FIG. 9a being a cross section of the constitution (and particularly the direction of magnetization) of the recording film of the magnetic recording medium, FIG. 9b a graph of the temperature distribution inside the medium versus the position of the magnetic recording medium during reproduction, FIG. 9c a graph of the domain wall energy density in the reproduction layer, and FIG. 9d a graph of the force needed to move the domain wall of the reproduction layer; and

FIG. 10 is a diagram of the constitution of a device for recording and reproduction with a magnetic recording medium in an embodiment of the present invention.

### BEST MODE FOR CARRYING OUT THE INVENTION

The present invention will now be described in further detail through embodiments, however the present invention is not limited to these embodiments.

### Embodiment 1

An embodiment of the present invention will now be described through reference to the drawings.

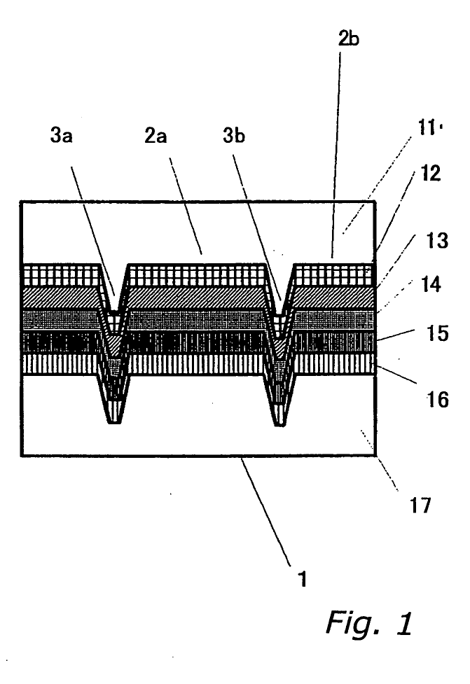

FIG. 1 is a cross section of the structure of the magnetic recording medium 1 (hereinafter referred to as a magnetic disk) in Embodiment 1 of the present invention. In FIG. 1, there is a transparent disk substrate 11 composed of polycarbonate, over which is a dielectric layer 12, over which is a magnetic recording film (reproduction layer 13, intermediate layer 14, recording layer 15), and over this is a dielectric layer 16 that protects the recording film. Over this is provided an overcoat layer 17 for further protecting the recording film. The recording layer 15 has magnetic anisotropy in the direction perpendicular to the film plane.

The magnetic disk 1 has guide grooves, comprising track grooves 2 for recording information, and lands 3. When the disk comprises pit regions for a servo and data regions where information is recorded, prepits are formed in the pit regions for tracking servo and address detection.

The magnetic recording medium of Embodiment 1 of the present invention shown in FIG. 1 is constituted such that it can be applied to a magnetic recording medium with which the recording and reproduction of recording marks recorded at high density are possible by focusing a laser spot on the recording film and using an optical head for recording, reproduction, and detection of signals.

With a recording and reproduction device in which the magnetic disk of this embodiment is used, during the recording of information, the disk is rotated, and a recording signal modulated according to an information signal causes the laser beam to be modulated by a magnetic head while being emitted from an optical head, thus effecting recording. During signal reproduction, a laser spot whose polarization plane has been aligned is emitted from the optical head, and polarization plane rotation of light reflected or transmitted by the recording magnetic domains is detected, thus effecting reproduction.

However, when the recording of particularly fine marks was attempted with a conventional recording medium, movement of the magnetic domain wall resulted in expansion or annihilation of the recording magnetic domains, making stable recording impossible. This problem was particularly pronounced when the recording density was high, and poor thermal stability created problems with reliability when the product was stored for extended periods.

The recording film in this embodiment will now be described in further detail.

In FIG. 1, the laminated magnetic recording film (13, 14, and 15) is formed over the disk substrate 11 composed of polycarbonate via the dielectric layer 12. The magnetic recording film is made up of the recording layer 15 in which information is held, the reproduction layer 13 for detecting information by the movement of magnetic domain wall, and the intermediate isolating or switching layer (or intermediate layer) 14 for controlling the exchange coupling between the reproduction layer 13 and the recording layer 15. The dielectric layer 16 and the overcoat layer 17 are further formed over the magnetic recording film.

The magnetic recording medium of Embodiment 1 of the present invention shown in FIG. 1 is constituted such that a DWDD system, with which magnetically induced super-resolution reproduction is possible by increasing the signal detection sensitivity during reproduction by successively moving the shifted magnetic domain wall according to the temperature gradient produced by the laser beam, and using an optical head to detect the movement of this domain wall, can be applied to a magnetic recording medium.

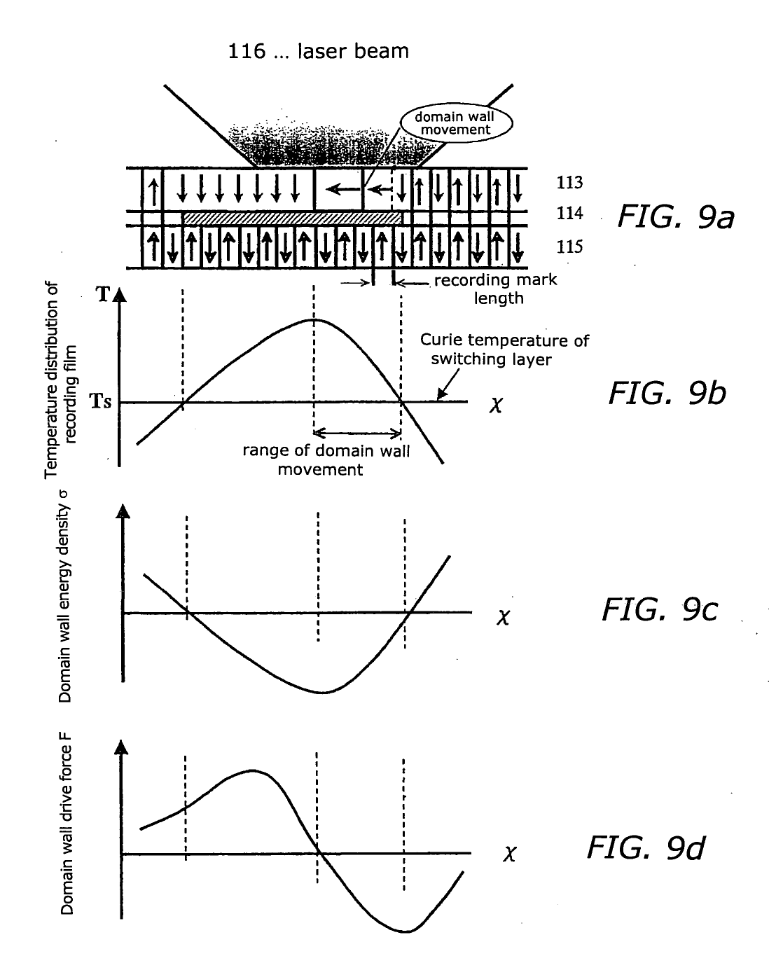

The laminated recording film constituted as above is an example of a DWDD (Domain Wall Displacement Detection) system, in which the movement of the domain wall is utilized to increase the amplitude of reproduction signals and the signal quantity. As discussed in Japanese Laid-Open Patent Application H6-290496, for instance, the recording layer comprises a magnetic film having a large interfacial coercivity, the reproduction layer that moves the domain wall is a magnetic film having a small interfacial coercivity, and the intermediate layer used for switching is a magnetic film having a relatively low Curie temperature. Therefore, the key is to use a magnetic film that allows the use of a DWDD system in order to maximize amplitudes of reproduction signals, and the film structure is not limited to the above. The reproduction principle of the above-mentioned DWDD system will be described through reference to FIG. 9.

FIG. 9a is a cross section of a recording film of a rotating magnetic disk. On a disk substrate and a dielectric layer (not shown) is formed a recording film with a three-layer structure comprising a reproduction layer 113, an intermediate layer 114, and a recording layer 115, over which is formed (though not depicted) a dielectric layer and an overcoat layer or lubricating sliding layer.

The reproduction layer 113 is made from a magnetic film material with low magnetic disk coercive force, the intermediate layer 114 is a magnetic film with a low Curie temperature, and the recording layer 115 is a magnetic film capable of stably holding a recording magnetic domain even at a small domain diameter. With this magnetic recording medium, the reproduction layer 113 forms a guard band or the like between recording tracks, thereby forming a magnetic domain structure including an unclosed domain wall.

As shown in the drawing, an information signal is formed as a recording magnetic domain that has been thermo-magnetically recorded in the recording layer 115. When not irradiated with the laser spot, and therefore at room temperature, the recording film is securely exchange-coupled to each of the recording layer 115, the intermediate layer 114, and the reproduction layer 113, so the recording magnetic domain of the recording layer 115 is transferred directly to the reproduction layer 113.

FIG. 9b is a graph of the relation between the temperature T of the recording film and the position χ corresponding to the cross section of FIG. 9a. As seen in this graph, during reproduction of a recording signal, the disk rotates and is irradiated along its track with a reproduction beam spot produced by the laser beam. Here, the recording film has the temperature distribution shown in FIG. 9b, there is a temperature region Ts in which the intermediate layer 114 (or intermediate isolating layer, or switching layer) is over the Curie temperature Tc, and exchange coupling between the reproduction layer 113 and the recording layer 115 is blocked.

When the disk is irradiated with the reproduction beam, as seen by the dependence on the domain wall energy density σ in FIG. 9c, there is a gradient in the domain wall energy density σ in the χ direction of the disk rotation direction corresponding to the positions in FIGS. 9a and 9b, so as shown in FIG. 9d, a force F that drives the domain wall acts on the domain wall in each layer at the position χ.

As shown in the drawing, the force F acting on the recording film acts to move the domain wall toward a lower domain wall energy density σ. The reproduction layer 113 has a low domain wall coercive force and a high domain wall mobility, so with just the reproduction layer 113 when it has an unclosed domain wall, the domain wall readily moves under this force F. Therefore, the domain wall of the reproduction layer 113 instantly moves to the region in which the temperature is high and the domain wall energy density is low, as indicated by the arrow.

As a result, regardless of the size of the recording magnetic domain, the size of the reproduction magnetic domain is always at a specific maximum amplitude. Accordingly, when signal reproduction is performed with an optical head or with a GMR head or other such magnetic head, the temperature gradient produced by the light beam or the like expands the transfer magnetic domain in the reproduction layer 113, thereby always resulting in a signal quantity of the specific maximum amplitude.

Next, the constitution and production method of the magnetic disk 1 in Embodiment 1 of the present invention will be described in detail.

As shown in FIG. 1, a structure including a recording film (a magnetic thin film) is formed by lamination on the disk substrate 11. Pit regions and data regions are formed in the recording track of the disk substrate 11. The track pitch of the magnetic disk 1 in this embodiment is 0.3 μm.

First, the disk substrate 11 shown in the drawing is formed by injection molding using a stamper having grooves and lands.

Next, a silicon target is placed in a DC magnetron sputtering device, and the disk substrate is fixed in a substrate holder, after which the inside of the chamber is evacuated with a turbo molecular pump to a high vacuum of 7×10⁻⁶ Pa or less. The residual amount of oxygen becomes relatively larger, since the turbo molecular pump is used. With this vacuum evacuation maintained, argon gas and N₂ gas are introduced into the chamber until 0.3 Pa is reached, and the substrate is rotated while the dielectric layer 12 (a dielectric composed of SiN) is formed in a thickness of 50 nm by reactive sputtering.

Argon gas is then introduced into the chamber until 0.5 Pa is reached, and the substrate is rotated while the reproduction layer 13 (GdFeCo) is formed in a thickness of 35 nm using targets of Gd, Fe, and Co, and the intermediate layer 14 (TbFeCoCr) is formed in a thickness of 20 nm using targets of Tb, Fe, Co, and Cr, with both of these layers being formed by DC magnetron sputtering. A sputtering gas obtained by mixing argon gas with H₂ (1.0% partial pressure) is introduced into the chamber until 2.5 Pa was reached, and the recording layer 15 (TbFeCo) is formed in a thickness of 100 nm by DC magnetron sputtering using the same targets as above.

During this recording layer formation, the recording layer is grown in an atmosphere containing hydrogen, so that there will be uptake of elemental hydrogen or a hydrogen compound in the recording layer 15. There may be hydrogen uptake in the intermediate layer 14 as well, but the hydrogen content in the recording layer 15 is greater than that of the intermediate layer 14 or the reproduction layer 13.

More specifically, there is localized hydrogen uptake in the recording layer 15. The phrase “localized hydrogen uptake” means a state in which a state of bonding with a specific element forms a strong film structure, rather than the elemental hydrogen being uniformly dispersed in the recording layer. More specifically, in this embodiment, the hydrogen is in a state of localized bonding with terbium as a rare earth metal. It is preferable if the recording layer includes at least one element selected from among Tb, Gd, Dy, Nd, Ho, Pr, and Er. Also, if the recording layer has a columnar structure, the elemental hydrogen uptake is localized in the structural units of the column structure. Alternatively, if the recording layer has a superlattice-like laminar structure, the hydrogen uptake is localized at the interface of the laminar structure.

The thickness of the recording layer 15 is at least 20 nm and no more than 400 nm, and the thickness of the intermediate layer 14 is at least 5 nm.

The desired film composition can be obtained by adjusting the ratio in which power is applied to the targets.

With the manufacturing method in an embodiment of the present invention, a recording layer with a large (18 koe) coercive force at room temperature and large magnetic anisotropy in the direction perpendicular to the film plane can be formed by adjusting the composition in film formation by setting the power level of each target such that the compensation composition temperature is 70° C. and the Curie temperature is 310° C. Also, if sputtering is performed in argon gas containing hydrogen, a stable recording magnetic domain can be formed even when the information signal is recorded in a very tiny magnetic domain. Also, excellent recording and reproduction, with little degradation in signal characteristics, will be possible even in repeated recording and reproduction of signals.

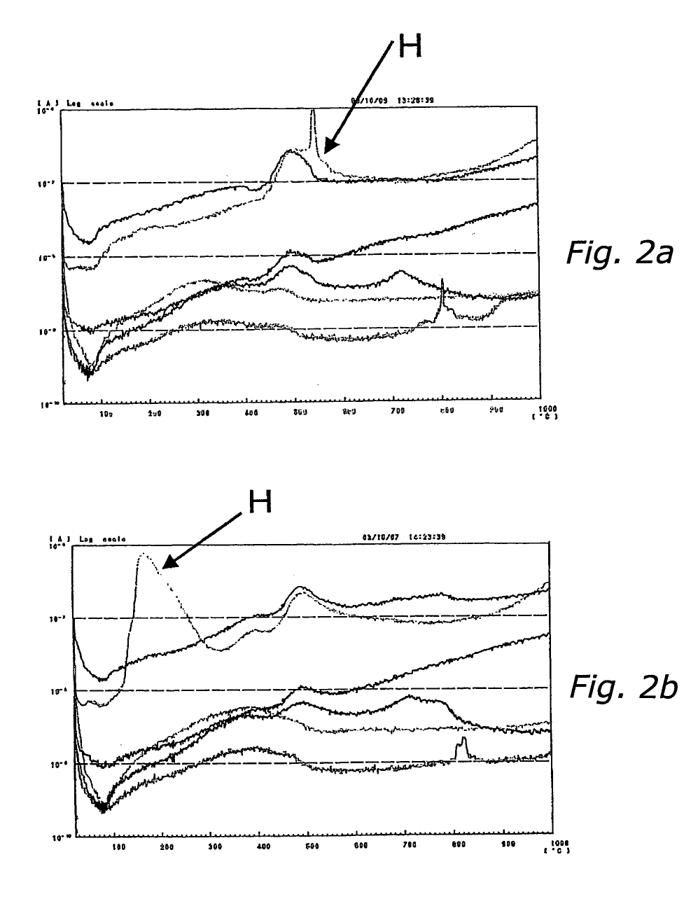

FIG. 2a is a graph of the TDS (thermal desorption spectrometry) analysis results of thermal desorption gas for the recording layer in this embodiment, and FIG. 2b is a graph of the TDS analysis results of thermal desorption gas for a conventional recording layer. With the recording layer of this embodiment shown in FIG. 2a, the desorption temperature during temperature elevation is high (over 500° C.), and despite the recording layer being an amorphous material, the recording layer material is securely bonded to the hydrogen. Furthermore, the bonding state is localized on the high temperature side. Analysis of the relation between the various elements constituting the recording layer material reveals that the bond with rare earth metals is extremely strong. As a result, a recording layer with large magnetic anisotropy in the direction perpendicular to the film plane can be formed by bonding hydrogen and a rare earth metal while forming a fine structure in the recording layer. Increasing the magnetic anisotropy in the direction perpendicular to the film plane increases the coercive force of the recording film and raises the angular ratio, affording more stable magnetic characteristics. As a result, it is possible to form a recording film with a stable recording magnetic domain even when recording at high density.

In contrast, with the conventional recording layer shown in FIG. 2b, the thermal desorption temperature is low (under 250° C.) and a large quantity of hydrogen gas with weak bonding strength at low temperature is taken up, which leads to a decrease in magnetic anisotropy. Also, if the sputtering pressure is lowered in an effort to suppress this hydrogen uptake, it is more difficult to obtain a microstructure, so the domain wall coercive force decreases and the movement of the domain wall creates problems in terms of stable recording at high density.

Therefore, if too much hydrogen is taken up, there is a tendency for the magnetic anisotropy in the direction perpendicular to the film plane to decrease in a TbFeCo recording layer, but equivalent or better stabilization will be obtained even when recording tiny marks as long as the recording layer has a hydrogen content of at least 0.2 at % and no more than 4.0 at %, and preferably at least 0.2 at % and no more than 2.0 at %, and especially if there is a bonded state between the recording layer and hydrogen with a high desorption temperature of at least 500° C.

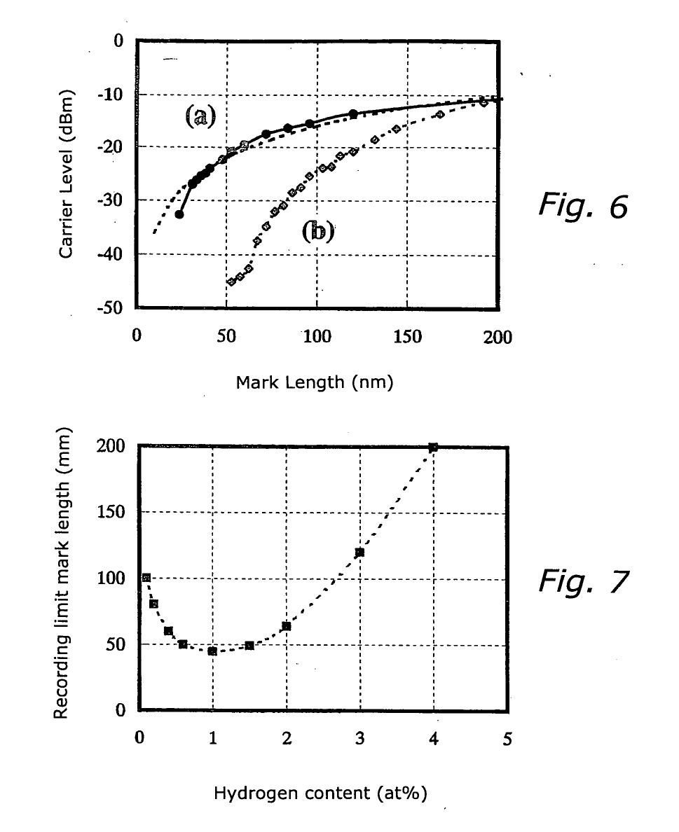

FIG. 6 is a graph of the dependence of the signal quantity on the recording mark length in the case of FIGS. 2a and 2b, and reveals the following. With the conventional recording layer of FIG. 2b, at a mark length of 100 nm or less, there is a sharp decrease in signal quantity, and fine recording marks cannot be recorded stably on the recording layer. In contrast, with the recording layer of the present invention of FIG. 2a, it is possible to record fine recording domains of 50 nm or smaller.

FIG. 7 is a graph of the dependence of the limit mark length on the elemental hydrogen content, and reveals the following. As long as the elemental hydrogen content in the recording film is between 0.2 and 2.0 at %, fine marks of 60 nm or smaller can be stably recorded. Here, the uptake of elemental hydrogen into the recording film can be adjusted as above by keeping the hydrogen partial pressure between 0.2 and 20% with respect to neon, argon, krypton, or xenon sputtering gas during the production of the recording film.

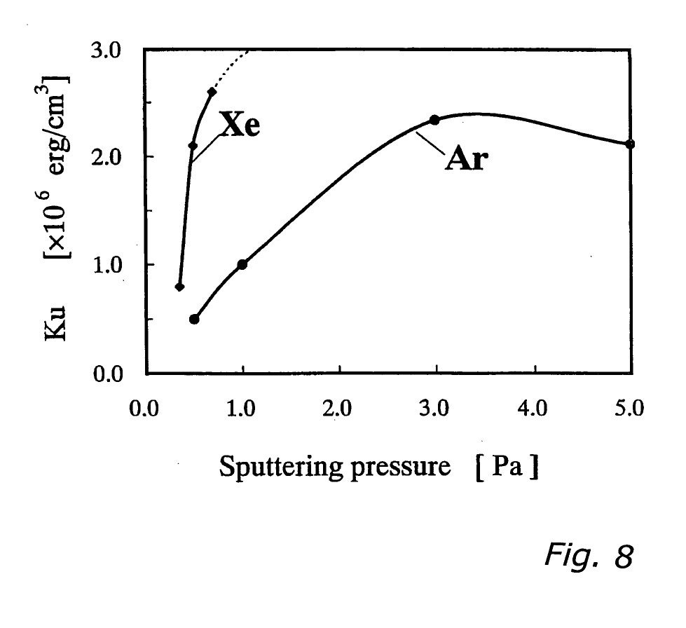

FIG. 8 is a graph of the change in magnetic anisotropy versus the sputtering pressure using argon or xenon, and reveals the following. When sputtering with xenon, a film of large magnetic anisotropy Ku can be formed by sputtering at a lower pressure than with argon. As a result, the sputtered molecules adhere to the substrate at higher energy, making it less likely that impurity gases other than elemental hydrogen will be incorporated into the recording film. Also, since magnetic anisotropy increases as well, it is possible to stably form a finer recording domain. This tells us that xenon is preferable to argon. In other words, krypton or xenon has larger effects compared to neon or argon.

With a conventional magnetic recording medium, particularly when fine marks are to be recorded, movement of the magnetic domain wall resulted in expansion or annihilation of the recording magnetic domain, making stable recording impossible. This problem was particularly pronounced when the recording density was high, and poor thermal stability created problems with reliability when the product was stored for extended periods.

In contrast, the magnetic recording medium of the present invention is a magnetic recording medium in which the recording layer is formed on a disk substrate, and the recording layer is bonded containing elemental hydrogen, which affords better mark stability in high density recording. Also, even if there should be changes in the environment temperature or the like, the fine structure of the recording film can still be stabilized, so it is possible to obtain a magnetic recording medium with excellent signal characteristics and excellent stability with respect to temperature change (specifically, there is less change in film characteristics as a result of environmental changes, such as when the medium is left at a high temperature).

### Embodiment 2

An embodiment of the present invention will now be described through reference to the drawings.

The structure of the magnetic disk in Embodiment 2 of the present invention has the same cross sectional structure as in Embodiment 1 as shown in FIG. 1. In FIG. 1, just as in Embodiment 1, there is a transparent disk substrate 11 composed of glass and a dielectric layer 12 formed on the substrate 11. A magnetic recording film composed of a reproduction layer 13, a intermediate layer 14, and a recording layer 15 is formed over the dielectric layer 12, and over this is then formed a dielectric layer 16 for protecting the recording film. Over this is provided an overcoat layer 17 for further protecting the recording film.

The magnetic disk 1 has guide grooves, comprising track grooves 2 for recording information, and lands 3. When the disk comprises pit regions for a servo and data regions where information is recorded, prepits are formed in the pit regions for tracking servo and address detection.

The recording film of this embodiment will now be described in further detail.

In FIG. 1, the laminated magnetic recording film (13, 14, and 15) is formed over the disk substrate 11 composed of glass via the dielectric layer 12. The magnetic recording film is made up of the recording layer 15 in which information is held, the reproduction layer 13 for detecting information by the movement of magnetic domain wall, and the intermediate isolating or switching layer (or intermediate layer) 14 for controlling the exchange coupling between the reproduction layer 13 and the recording layer 15. The dielectric layer 16 and the overcoat layer 17 are further formed over this in order to protect the magnetic recording film.

The magnetic recording medium of Embodiment 2 of the present invention is the same as that of Embodiment 1 of the present invention in that a DWDD system, with which magnetically induced super resolution reproduction is possible by increasing the signal detection sensitivity during reproduction by successively moving the shifted magnetic domain wall according to the temperature gradient produced by the laser beam, and using an optical head to detect the movement of this domain wall, can be applied to a magnetic recording medium.

With this constitution, regardless of the size of the recording magnetic domain, the size of the reproduction magnetic domain is always at a specific maximum amplitude. Accordingly, when signal reproduction is performed with an optical head or with a GMR head or other such magnetic head, the temperature gradient produced by the light beam or the like expands the transfer magnetic domain in the reproduction layer, thereby always resulting in a signal quantity of the specific maximum amplitude.

The magnetic recording medium of Embodiment 2 of the present invention can be applied to a magnetic recording medium in which the laser beam is emitted from the disk substrate side wherein the recording film is formed, and the magnetic domains of the reproduction layer expanded by domain wall movement are detected as rotation of the polarized plane of the incident light spot, which makes possible recording and reproduction of recording marks smaller than the detection limit of the laser spot during reproduction.

Next, the production method of the magnetic disk in Embodiment 2 of the present invention will be described in detail.

As shown in FIG. 1, a structure including a recording film (a magnetic thin film) is formed by lamination on the disk substrate 11. Pit regions and data regions are formed in the recording track of the disk substrate 11, and pits and grooves are formed by imprinting. The track pitch of the magnetic disk 1 in this embodiment is 0.25 μm.

First, a target is placed in a DC magnetron sputtering device, and the disk substrate is fixed in a substrate holder, after which the inside of the chamber is evacuated with a turbo molecular pump to a high vacuum of 8×10⁻⁶ Pa or less. With this vacuum evacuation maintained, argon gas and N₂ gas are introduced into the chamber until 0.4 Pa is reached, and the substrate is rotated while the dielectric layer 12, composed of an AlTiN film, is formed by reactive sputtering.

With this vacuum evacuation maintained, the vacuum chamber is then moved, argon gas is then introduced into the chamber until 0.6 Pa is reached, and the substrate is rotated while the reproduction layer 13 (GdFeCoCr) is formed in a thickness of 30 nm by DC magnetron sputtering using an alloy target of GdFeCoCr. With this vacuum evacuation maintained, the vacuum chamber is then moved, argon gas is then introduced into the chamber until 1.5 Pa is reached, and the substrate is rotated while the intermediate layer 14 (TbFeCoCr) is formed in a thickness of 20 nm by DC magnetron sputtering using an alloy target of TbFeCoCr. Further, with this vacuum evacuation maintained, krypton gas containing 0.5% (partial pressure) hydrogen gas is introduced into the chamber until 1.0 Pa is reached, and the substrate is rotated while the recording layer 15 (TbFeCo) is formed in a thickness of 70 nm by DC magnetron sputtering using an alloy target of TbFeCo.

The desired film composition for the TbFeCo, TbFeCoCr, and GdFeCoCr films can be obtained by adjusting the compositional ratios of the alloy targets and the film formation conditions.

Argon gas and N₂ gas are then introduced into the chamber until 0.3 Pa is reached, and the substrate is rotated while the dielectric layer 16 (a dielectric composed of AlTiN) is formed in a thickness of 4 nm by reactive sputtering.

This dielectric layer 16 is then spin coated with a UV-setting resin composed of a polyurethane material, and the coating is cured by being irradiated with UV rays, which forms the overcoat layer 17.

Here, the film composition of the recording layer 15 composed of TbFeCo is adjusted such that the compensation composition temperature is −50° C. and the Curie temperature is 310° C., and the film characteristics are such that the coercive force Hc of the recording layer 15 decreases as the temperature is raised from room temperature.

Also, with the magnetic recording medium in this embodiment, since signals are reproduced by a DWDD system by means of the temperature gradient under irradiation with a light beam, the reproduction layer 13 is amorphous and does not have a fine structure, and this film structure facilitates domain wall movement. In contrast, the recording layer 15 has a fine recording film structure as a result of the above manufacturing method, and even when very small magnetic domains are recorded, stable recording magnetic domains can be formed. Also, recording and reproduction with excellent signal characteristics are possible even when the laser spot is repeatedly used for recording and reproduction.

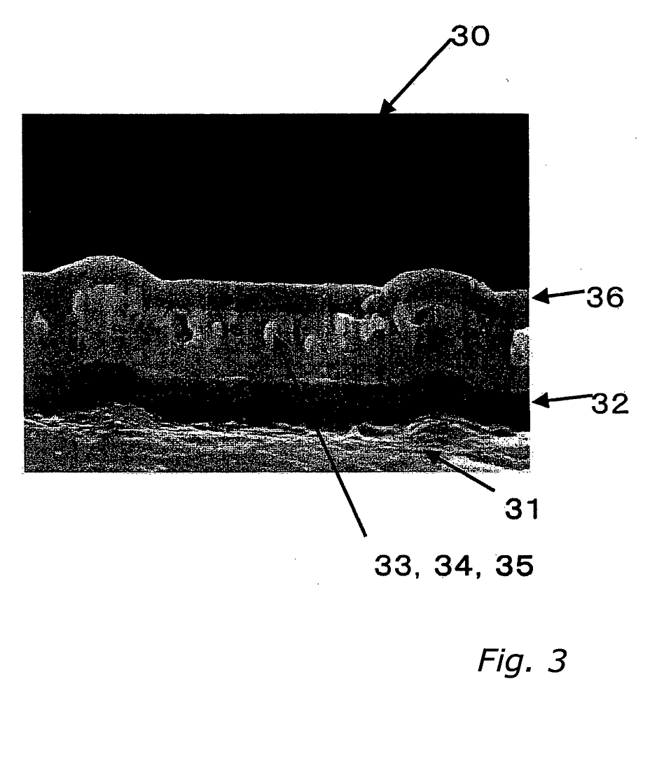

FIG. 3 is an SEM micrograph of a cross section of a structure of a magnetic recording medium 30 in this embodiment. As shown in FIG. 3, a dielectric layer 32, a reproduction layer 33 with an amorphous film structure, an intermediate layer 34, and a recording layer 35 having a fine columnar structure are formed over a disk substrate 31. Over all this is formed a dielectric protective layer 36.

Therefore, with a conventional magnetic recording medium, particularly when the recording of fine marks was attempted, a problem was that the movement of the domain wall expanded or annihilated the recording magnetic domains, making stable recording impossible. This problem was particularly pronounced when the recording density was high, and poor thermal stability created problems with reliability when the product was stored for extended periods.

In contrast, the magnetic recording medium of the present invention is a magnetic recording medium in which a recording layer having a microstructure such as that shown in FIG. 3 is formed on a disk substrate, and the recording layer is bonded containing elemental hydrogen, which stabilizes the film structure, increases the coercive force through pinning sites of the domain walls, and affords good mark stability when recording at high density. Also, even if there should be changes in the environment temperature or the like, the fine structure of the recording film can still be stabilized, so it is possible to obtain a magnetic recording medium with excellent signal characteristics and excellent stability with respect to temperature change.

Also, the track pitch was 0.25 μm in this embodiment, but the effect will be even better if the width of the grooves in which information is recorded is 0.6 μm or less, and the recording domains have a minimum mark length of 0.3 μm for the recorded information.

Furthermore, grooves and pits were formed by imprinting on glass in this embodiment, but the effect will be similar with a constitution in which a photopolymer is cured to form the pits and grooves, or with a constitution in which the substrate is made from a plastic material.

As discussed above, with the constitution of this embodiment, even when recording and reproduction are performed at high density, stable recording domains can be formed, and excellent reproduction signal characteristics can be obtained. Also, because the recording magnetic domains of the information tracks are formed in a stable shape, cross write and cross talk from adjacent tracks can be reduced during recording and reproduction.

### Embodiment 3

An embodiment of the present invention will now be described through reference to the drawings.

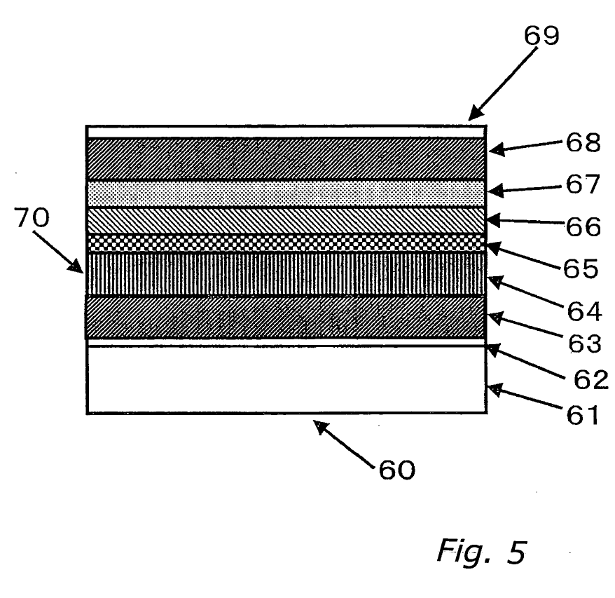

FIG. 5 is a cross section of the structure of a magnetic disk 60 in Embodiment 3 of the present invention. In FIG. 5, there are provided a transparent disk substrate 61 composed of glass, a base dielectric layer 63, and a magnetic recording film (64, 65, 66 and 67). The magnetic recording film is made up of a recording layer 64, an intermediate layer 65, a control layer 66, and a reproduction layer 67. A protective layer 68 and a solid lubricating protective layer 69 are further provided for protecting the recording film and sliding a magnetic head.

Here, the disk substrate 61 prior to the formation of the base dielectric layer 63 is such that a stamper in which pits have been formed is used to transfer its pattern to a photopolymer 62 coating the glass disk substrate 61, and this product is cured. With this constitution, pits are formed for tracking servo and address detection, and the recording track is designed to allow the detection of pit regions for the servo and data regions where information is recorded.

The magnetic recording medium of Embodiment 3 of the present invention shown in FIG. 5 is constituted such that it can be applied to a magnetic recording medium with which the recording and reproduction of recording marks recorded at high density are possible by irradiating with a laser beam from the disk substrate side and detecting recording and reproduction of signals with a magnetic head from the lubricating protective layer side where the recording layer 64 is formed. This constitution in which the recording and reproduction of signals are detected with an magnetic head can be applied to a magnetic recording medium which makes possible recording and reproduction of recording marks smaller than the detection limit of the laser spot during reproduction.

A characteristic of the recording film in this embodiment is that as the temperature T rises, the coercive force Hc decreases and the saturation magnetization Ms increases. As a result, the detection sensitivity of reproduction signals can be increased when a GMR head is used for reproduction.

With a magnetic disk recording and reproduction device in this embodiment, during the recording of information, the disk is rotated and the information is recorded with a magnetic head while the disk is irradiated with a laser spot along the track. The coercive force of the recording film here decreases at higher temperatures, which is why recording with a magnetic head is possible. Also, during recording and reproduction, the disk is irradiated with the laser beam and the temperature is raised while the recording magnetic domains are detected by the GMR head. Here, the saturation magnetization Ms rises along with the temperature, reaching its maximum at 40° C., so detection sensitivity with the GMR head is better by increasing a temperature and there is an increase in the reproduction signals.

In contrast, a problem with a conventional recording medium was that when tiny magnetic domains were recorded at high density, the domain walls of the recording magnetic domains moved, resulting in instability in the recording marks.

Furthermore, the recording marks change, depending on the floating magnetic field and the temperature characteristics thereof, along with fluctuation in the environment temperature, increases in the temperature of the magnetic disk during irradiation of the recording film with the laser beam, and so forth, and a problem was that these changes resulted in inferior reproduction signals. Other problems were cross talk and cross write, degradation of recording and reproduction signals, and decreased reproduction signal quantity.

Next, the constitution and production method of the magnetic disk 60 in Embodiment 3 of the present invention will be described in detail.

First, a stamper is used to transfer pits and grooves to the photopolymer 62 coating the glass substrate, and the material is cured by being irradiated with UV rays, thereby forming the disk substrate 61.

Next, a target is placed in a DC magnetron sputtering device, and the disk substrate is fixed in a substrate holder, after which the inside of the chamber is evacuated with a turbo molecular pump to a high vacuum of 6×10⁻⁶ Pa or less. With this vacuum evacuation maintained, argon gas and N₂ gas are introduced into the chamber until 0.3 Pa is reached, and the substrate is rotated while the base dielectric layer 63, composed of SiN, is formed in a thickness of 35 nm by reactive sputtering.

Next, during recording layer production, xenon gas containing 0.2% hydrogen is introduced until 0.5 Pa is reached, and an alloy target is used to form the recording layer 64 (TbFeCo) in a thickness of 50 nm by DC magnetron sputtering.

The inside of the chamber is put under a 1.5 Pa argon gas atmosphere, and the substrate is rotated while the intermediate layer 65, the control layer 66, and the reproduction layer 67 are formed by sputtering using alloy targets having the respective compositions thereof. The desired magnetic film composition for the TbFeCo, TbFeCoCr, and GdFeCo films can be obtained by adjusting the ratio in which power is applied to the targets.

The protective layer 68 composed of diamond-like carbon (DLC) is then formed in a thickness of 5 nm over the reproduction layer 67 by reactive RF sputtering using a carbon target in a mixed atmosphere of argon and CH₄. The solid lubricating protective layer 69 composed of perfluoropolyether (PFPE) is then formed by coating.

The track pitch of the magnetic disk 60 in this embodiment is 0.35 μm.

The recording layer 64 here is formed by adjusting the alloy target composition such that the compensation composition temperature is 130° C. and the Curie temperature is 320° C. This composition results in a coercive force of 8 koe at room temperature. Because the magnetic recording medium of the present invention is produced by the above manufacturing method, a hydrogen compound with a rare earth metal or a transition metal is present on the disk substrate, so even when recording at high density, it is possible to realize a magnetic recording medium in which the recording magnetic domain is stable and the signal characteristics are excellent, and a method for manufacturing this medium. Also, even when tiny magnetic domains are recorded by a magnetic head, stable recording magnetic domains can be formed, and even in repeated recording and reproduction, the result will be a magnetic recording medium whose signal characteristics are excellent and which has excellent stability with respect to temperature changes.

Also, because the film characteristics are such that the coercive force Hc of the recording layer decrease as the temperature is raised from room temperature, the coercive force is lower at elevated temperatures, making recording with a magnetic head easier, and making it possible to record without a large recording magnetic field.

With the magnetic recording medium of this embodiment, when signals are reproduced by a DWDD system by means of the temperature gradient under irradiation with a light beam, the reproduction layer in which the signal from the recording layer has been transferred and expanded has a composition with which the saturation magnetization Ms is at its maximum at 90° C., so the effect is to further increase the reproduction signal.

Also, with the above constitution, even when tiny magnetic domain are recorded, stable recording magnetic domains can be formed, and even in repeated recording and reproduction with a magnetic head, recording and reproduction with excellent signal characteristics will be possible.

The magnetic disk 60 in this embodiment was described above for a constitution in which the disk substrate 61 was coated with a photopolymer 62, but it is also possible to employ a constitution in which a glass substrate is directly imprinted, a constitution in which the surface features of the disk substrate are changed by etching or the like, a constitution in which a glass substrate is directly worked, or transfer is effected by melting, a flat metal substrate or a plastic substrate is molded, for example.

Furthermore, in this embodiment the track pitch was 0.35 μm, but the effect will be even better if the width of the recording track in which information is recorded is 0.6 μm or less, and the recording domains have a minimum mark length of 0.35 μm for the recorded information.

As discussed above, with the constitution of this embodiment, stable reproduction signal characteristics are obtained even in recording and reproduction at high density. Further, since the recording magnetic domains in the information track are formed in a stable shape, cross write and cross talk from adjacent tracks can be reduced during recording and reproduction.

### Embodiment 4

An embodiment of the present invention will now be described through reference to the drawings.

The magnetic disk 60 in Embodiment 4 of the present invention has the cross sectional structure shown in FIG. 5, just as in Embodiment 3. As shown in FIG. 5, there are provided a flat disk substrate made of polished glass, over which is formed a magnetic recording film group composed of a base dielectric layer, a recording layer, an intermediate layer, a control layer, and a reproduction layer. This magnetic recording film is further protected by a protective layer that allows the magnetic head to slide, and a lubricating protective layer.

The magnetic disk 60 has a constitution in which pits are formed for tracking servo and address detection, and information is recorded in data regions. The pits are used for tracking servo and address detection, produced in a shape of different surface roughness and bumps, or are magnetically transferred after the formation of the magnetic recording film, or are magnetically recorded with a servo writer or the like.

When the pits are formed by changing the surface shape of the disk substrate 61, such as making bumps or varying the surface roughness, they are produced by transfer to the disk substrate 61 by imprinting or the like, using a stamper on which prepits have been formed, using a photoresist or the like on a glass base.

Alternatively, they are formed directly on the disk substrate or a stamper by controlling the surface roughness, the bump shape, or the like of the pits by ion etching.

Alternatively, the bottoms of the prepits formed in the stamper can be combined with ion etching so that the surface roughness is also changed.

The magnetic recording medium of Embodiment 4 of the present invention shown in FIG. 5 can be applied to a magnetic recording medium with which the recording and reproduction of recording marks recorded at high density are possible by forming the protective layer 68 and the solid lubricant protective layer 69 on a thin film surface on which the magnetic recording film (64, 65, 66, and 67) has been formed, and performing the recording and reproduction detection of signals with a magnetic head from over the lubricating layer side. This constitution in which the recording and reproduction detection of signals are performed with a magnetic head can be applied to a magnetic recording medium which makes possible recording and reproduction of recording marks smaller than the detection limit of the laser spot during reproduction.

The track pitch of the magnetic disk 60 in this embodiment is 0.4 μm, and the pit diameter is 0.35 μm.

With a recording and reproduction device in which the magnetic disk of this embodiment is used, during the recording of information, the disk is rotated while the information is recorded with a magnetic head. The recording layer 64 here has a coercive force of 10 koe and lower, which is why recording with a magnetic head is possible. Also, during recording and reproduction, signals from the recording magnetic domains are detected with a GMR head. If the constitution here involves irradiation with a laser beam, and if a recording layer is used whose characteristics are such that the coercive force decreases as the temperature is raised, and the saturation magnetization Ms rises along with the temperature, and the composition is adjusted such that the maximum is reached at 70° C., detection sensitivity with the GMR head will be better and there will be an increase in the reproduction signals. Also, the reproduction signal amplitude can be further expanded with a combination of DWDD system.

Next, the production method of the magnetic disk 60 in Embodiment 4 of the present invention will be described in detail.

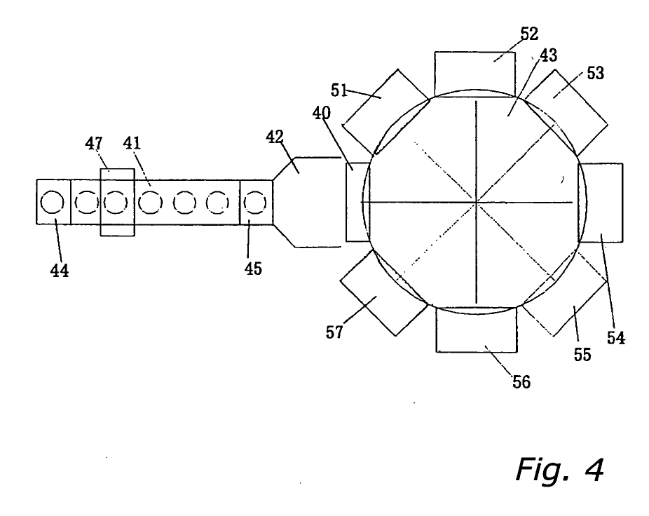

FIG. 4 is a diagram of the structure of the apparatus used to manufacture the magnetic recording medium in an embodiment of the present invention. As shown in FIG. 4, the magnetic recording medium manufacturing apparatus comprises a degasification chamber 41 and a main chamber 43, which are connected by a loading and unloading vacuum chamber 42 of the main chamber. The degasification chamber 41 comprises a loading chamber 44, an unloading chamber 45, and a heating chamber 47, all of which are linked. A plurality of processing chambers 51, 52, 53, 54, 55, 56, and 57 are connected to the main chamber 43, and the magnetic disk moves through the main chamber 43 as films are formed in the various vacuum chambers.

First, the disk substrate 61 is conveyed from the loading chamber 44 in the atmosphere of the degasification chamber 41, in the course of which the disk substrate is heated in the heating chamber 47. It then moves through the degasification chamber 41 to remove any adsorbed gas from the disk substrate 61. The loading chamber 44 of the degasification chamber 41 is connected to the loading and unloading chamber 42 of the main chamber, and the disk substrate 61 has a substrate holder and a mask fixed thereto and moves through a vacuum conveyance chamber 40 to the main chamber 43.

From the main chamber 43 it moves to the vacuum processing chamber 51, which is evacuated with a turbo molecular pump to a high vacuum of 8×10⁻⁶ Pa or less. In the vacuum processing chamber 51, with its atmosphere still maintained under vacuum evacuation, argon gas and O₂ gas are introduced into the chamber until 0.3 Pa is reached, and the substrate is rotated while the base layer 63 composed of TaO is formed in a thickness of 10 nm by reactive sputtering.

The disk then goes through the main chamber 43 and moves to the vacuum processing chamber 52 for forming a recording layer film of TbFeCo. Here, the vacuum processing chamber 52 is evacuated with a turbo molecular pump to a high vacuum of 7×10⁻⁶ Pa or less, and the hydrogen partial pressure in the vacuum processing chamber 52 at this point is 2×10⁻⁸ Pa, which is at least 10 times the content of nitrogen and oxygen. This hydrogen partial pressure can be controlled by varying the rotational speed of the turbo molecular pump used for vacuum evacuation. With this vacuum evacuation maintained, argon gas is introduced into the vacuum processing chamber 52 until 1.8 Pa is reached, and the substrate is rotated while the recording layer 64 of TbFeCo is formed in a thickness of 60 nm by DC magnetron sputtering using an alloy target of TbFeCo. The desired TbFeCo film composition can be obtained by adjusting the composition of the alloy target and the film formation conditions. Also, when the film formation conditions include a high hydrogen partial pressure in the vacuum processing chamber, hydrogen is taken up into the TbFeCo recording layer 64 during film formation by sputtering, and this forms a micro film structure. Actually, a columnar fine structure can be formed just as shown in the cross section of FIG. 3.

The deposition rate during film formation of the base layer 63 is lower than the deposition rate during film formation of the recording layer 64. The deposition rate during film formation of the recording layer 64 is at least 2 nm/sec and no more than 20 nm/sec.

The disk substrate then goes through the main chamber 43 and moves successively to the vacuum processing chambers 53, 54, and 55, where the intermediate layer 65 of TbFeCoAl, the control layer 66 of TbFeCoCr, and the reproduction layer 67 of GdFeCo are successively formed by lamination. The thickness of the intermediate layer 65 of TbFeCoAl here is set to 10 nm, the thickness of the control layer 66 of TbFeCoCr to 1 μm, and the thickness of the reproduction layer 67 of GdFeCo to 35 nm.

The effect will be the same or better compared to the above-mentioned case, if the hydrogen partial pressure in the vacuum processing chambers 53 and 54 is increased to 2×10⁻⁸ Pa during the formation of the intermediate layer 65 of TbFeCoAl and the control layer 66 of TbFeCoCr, just as in the formation of the recording layer 64 of TbFeCo.

The disk substrate is then moved to the vacuum processing chamber 56, where the protective layer 68 composed of diamond-like carbon (DLC) is formed in a thickness of 3 μm over the magnetic recording film (64, 65, 66, and 67) by reactive RF sputtering using a carbon target in a mixed atmosphere of argon and CH₄. Then, the magnetic disk 60 thus produced is cooled in the vacuum processing chamber 57, after which it goes through the loading and unloading vacuum chamber 42 and is taken outside through the unloading chamber 45 of the vacuum apparatus.

The solid lubricating protective layer 69 composed of perfluoropolyether (PFPE) is then formed in a thickness of 2 nm by coating while lifting with a dipping apparatus.

The recording layer 64 composed of TbFeCo here is formed by adjusting the film composition by setting the target composition and the conditions such that the compensation composition temperature is 140° C. and the Curie temperature is 330° C.

In another method that may be used, after the formation of the recording layer 64, it is held in an argon atmosphere containing 20% hydrogen under a vacuum assured by the vacuum processing chambers 52 and 53, for further occlusion and adsorption of hydrogen.

Because of the composition of this recording layer, and the bonding with elemental hydrogen, the micro film structure is stable and the coercive force at room temperature is at least 10 koe. As a result, even when tiny magnetic domain are recorded by a magnetic head, stable recording magnetic domains can be formed, and even in repeated recording and reproduction with a magnetic head, recording and reproduction with excellent signal characteristics will be possible.

A problem encountered with a conventional magnetic recording medium was that the recording of fine marks was not stable because of annihilation caused by expansion or contraction of the recorded magnetic domains as a result of domain wall movement. Also, thermal fluctuation of magnetic grains became a problem as the environment temperature varied or as the temperature of the magnetic disk rose when the recording film was irradiated with the laser beam, and this led to a problem in that the shape of the recording domain varied or deteriorated, or that there was cross talk, cross write, or degradation of recording and reproduction signals.

In contrast, with the magnetic recording medium of the present invention, the recording layer is stabilized by adding hydrogen to the recording layer by a simple method, so a magnetic recording medium whose recording characteristics are stable even when tiny magnetic domains are recorded at high density, and a method for manufacturing this medium, can be achieved. Also, the coercive force of the recording layer at room temperature is high, and even when the environment temperature or the like varies, stable recording magnetic domains can be recorded, so a magnetic recording medium with excellent signal characteristics and high reliability can be achieved.

Thus, with the constitution of this embodiment, stable reproduction signal characteristics can be obtained even in recording and reproduction at high density. Further, since the recording magnetic domains of the information tracks are formed in a stable shape, cross write and cross talk from adjacent tracks can be reduced during recording and reproduction.

### Embodiment 5

An embodiment of the present invention will now be described through reference to the drawings.

The magnetic disk 60 in Embodiment 5 of the present invention has the cross sectional structure shown in FIG. 5, just as in Embodiment 3. As shown in FIG. 5, there are provided a metal disk substrate composed of a polished aluminum alloy, over which is formed a magnetic recording film group composed of a base dielectric layer, a recording layer, an intermediate layer, a control layer, and a reproduction layer. This magnetic recording film is further protected by a protective layer that allows the magnetic head to slide, and a lubricating protective layer.

The magnetic disk 60 has a constitution in which prepits and data regions in which information is recorded are provided on the recording track. The prepits are used for tracking servo and address detection, comprising pits of different surface roughness or bumps, or are prepits formed by magnetic recording with a servo writer and so on.

When the disk substrate 61 has prepits of different surface roughness or bumps, a stamper on which pits have been formed is used and these are transferred to the metal disk substrate 61 by imprinting, or the bump shape, surface roughness, or the like of the pits is controlled by ion etching, for direction formation on the disk substrate or stamper.

When the base dielectric layer 63 composed of AgCu or ZnS—SiO₂ is formed on this disk substrate featuring bumps or surface roughness, the pits on the surface of the disk substrate 61 are also formed on the surface of the base layer 63.

As a result, pits are formed as servo pits with low surface roughness.

The magnetic recording medium of Embodiment 5 of the present invention having the constitution shown in FIG. 5 can be applied to a magnetic recording medium with which the laser beam is emitted from the lubricating layer side wherein the recording film is formed, and the recording and reproduction detection of signals are performed with a magnetic head, which makes possible recording and reproduction of recording marks smaller than the detection limit of the laser spot during reproduction.

The recording film in this embodiment has characteristics such that as the temperature T rises, the coercive force Hc decreases and the saturation magnetization Ms increases up to its maximum temperature.

With the magnetic recording medium of this embodiment, during the recording of information, the disk is rotated and the information is recorded with a magnetic head while the disk is irradiated with a laser spot along the track. The coercive force of the recording film here decreases at higher temperatures, which is why recording with a magnetic head is possible. Also, during recording and reproduction, the disk is irradiated with the laser beam and the temperature is raised while the recording magnetic domains are detected by the GMR head. Here, the saturation magnetization Ms rises along with the temperature, reaching its maximum at 100° C., so detection sensitivity with the GMR head is better and there is an increase in the reproduction signals.

However, a problem with a conventional recording medium was that when the recording film was irradiated with the laser beam, the recording magnetic domains became unstable as the temperature of the magnetic disk rose and as the temperature changed in the cooling process, and movement of the domain walls resulted in deterioration of the recording domains.

Next, the production method of the magnetic disk 60 in Embodiment 5 of the present invention will be described in detail.

As shown in FIG. 5, a constitution including a magnetic recording thin film is formed by lamination on the polished disk substrate 61 composed of metal. A recording track provided with prepits is formed on the disk substrate 61, and the track pitch of the magnetic disk 60 in this embodiment is 0.3 μm.

First, as shown in the drawing, a photopolymer is used to form pits on the surface of the disk substrate 61 composed of an aluminum alloy, and the pit pattern is etched through a mask with an ion gun, thereby forming prepits with a surface roughness Ra of at least 0.5 nm and different Ra values.

When magnetic prepits are formed here, magnetic transfer, a servo writer, or the like is used to record information after the formation of the recording film on the disk substrate.

Next, a sputtering device is used to produce the recording film and the protective layer, and the manufacturing apparatus used for this purpose can be a film formation apparatus with the same constitution as that in Embodiment 4 shown in FIG. 4.

First, the target is placed in the sputtering device, and the disk substrate is fixed in a substrate holder, after which the inside of the chamber is evacuated with a turbo molecular pump to a high vacuum of 8×10⁻⁶ Pa or less. With this vacuum evacuation maintained, argon gas is introduced into the chamber until 0.2 Pa is reached, and the substrate is rotated while the base layer 63 (a metal film composed of AgCu) is formed in a thickness of 20 nm, and then 0.4 Pa argon is introduced, and the base dielectric layer 63 composed of ZnS—SiO₂ is formed in a thickness of 10 nm, by RF magnetron sputtering.

With this vacuum evacuation maintained, argon gas is introduced into the chamber until 2.0 Pa is reached, and the substrate is rotated while the recording layer 64 of TbFeCo is formed in a thickness of 80 nm by DC magnetron sputtering using an alloy target of TbFeCo. The desired TbFeCo film composition can be obtained by adjusting the composition of the alloy target and the film formation conditions.

Next, the TbFeCo recording layer 64 is etched with an ion gun in an argon atmosphere containing at least 20 at % hydrogen in the vacuum process chamber 53, after which the recording layer 64 is held for another 60 seconds in an atmosphere containing 20 at % hydrogen. This results in hydrogen being taken up into the recording film, and the formation of a stable bonding state with the rare earth metal.

The smoothness of the surface of the recording layer 64 here can be adjusted by varying the etching conditions.

The intermediate layer 65, the control layer 66, and the reproduction layer 67 are then successively formed by sputtering, using alloy targets of the respective compositions, in an argon gas atmosphere of 1.5 Pa in the chamber. The magnetic recording film compositions of TbFeCo, TbFeCoCr, and GdFeCo here can be adjusted to the desired film compositions by adjusting the compositional ratios of the targets and the film formation conditions.

Then, the protective layer 68 composed of amorphous carbon (αC) is formed in a thickness of 7 nm over the reproduction layer 67 by DC sputtering using a carbon target in an argon atmosphere. The solid lubricant protective layer 69 composed of perfluoropolyether (PFPE) is then formed by spin coating at high rotation.

The recording layer 64 composed of TbFeCo here is formed by adjusting the film composition such that the compensation composition temperature is −20° C. and the Curie temperature is 310° C.

As a result, with the magnetic recording medium in this embodiment, the saturation magnetization Ms is at its maximum at 120° C., the temperature when the disk is irradiated with the light beam, and the coercive force Hc decreases as the temperature rises, so even when tiny magnetic domains are recorded, and even in repeated recording and reproduction with a magnetic head, recording and reproduction with excellent signal characteristics will be possible.

Thus, with the magnetic recording medium of this embodiment, during the recording of information, the disk is rotated and irradiated with the laser spot along the track while the recording magnetic field is modulated with a magnetic head. Here, the coercive force of the recording layer decreases at higher temperatures, which is why recording with the magnetic field of a magnetic head is possible. Also, during recording and reproduction, the disk is irradiated with the laser beam and the temperature is raised while the recording magnetic domains are expanded by domain wall movement using the above-mentioned DWDD system, while the recording magnetic domains are detected by the GMR head. Here, if the constitution is such that the saturation magnetization Ms of the reproduction layer rises along with the temperature, the reproduction signal will be largest at elevated temperatures, so detection sensitivity with the GMR head is better and there is an increase in the reproduction signals.

A problem with a conventional recording medium was that when the recording film was irradiated with a laser beam, the tiny magnetic domains deteriorated as the temperature of the magnetic disk rose. In particular, when the recording film was irradiated with a laser beam, reliability of the recording magnetic domains became unstable as the temperature of the magnetic disk rose and as the temperature changed in the cooling process, and movement of the domain walls resulted in deterioration of the recording domains, thereby deteriorating storage stability. Also, when servo pits were formed magnetically, the characteristics of the servo signal fluctuated, or there was an attendant decrease in the recording and reproduction characteristics, among other such problems.

In contrast, the magnetic recording medium of the present invention has a stable structure in which the recording layer contains hydrogen, which makes possible the stable recording of fine recording magnetic domains even if there are changes in the environment temperature, or if the temperature of the magnetic disk changes when the recording film is irradiated with the laser beam during recording and reproduction. As a result, when the temperature of the recording film is raised by the light beam or the like, and a signal is reproduced using a magnetic head such as a GMR head, the result is a magnetic recording medium with excellent thermal durability and excellent signal characteristics.

Also, with this embodiment, the track pitch was 0.3 μm in this embodiment, but the effect will be even better if the width of the grooves in which information is recorded is 0.6 μm or less, and the recording domains have a minimum mark length of 0.3 μm for the recorded information.

As discussed above, with the constitution of this embodiment, even when recording and reproduction are performed at high density, stable recording domains can be obtained. Also, because the recording magnetic domains of the information tracks are formed in a stable shape, cross write and cross talk from adjacent tracks can be reduced during recording and reproduction.

Next, a recording and reproduction device for the magnetic recording medium of this embodiment will be described in detail through reference to the drawings.

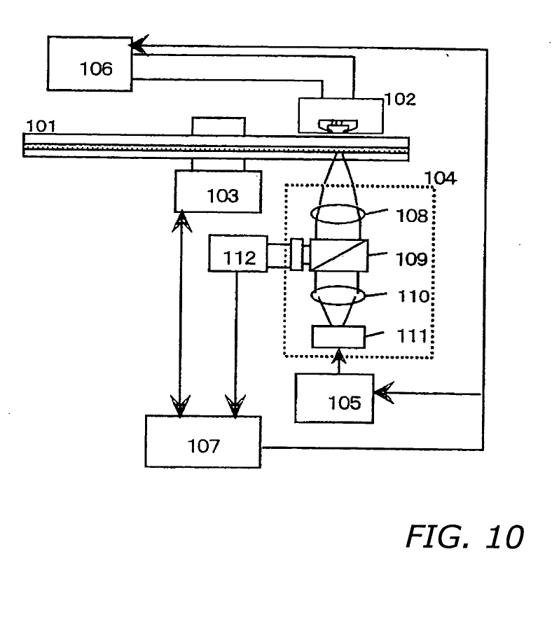

A recording and reproduction device for the magnetic recording medium in an embodiment of the present invention has the constitution shown in FIG. 10. As shown in FIG. 10, signals are recorded to or reproduced from a magnetic disk 101 attached to a spindle motor 103 by a magnetic head that is controlled by a magnetic head control and detection circuit 106. An optical head 104 performs recording and reproduction with the magnetic head while the disk is irradiated with a laser beam controlled by a laser drive circuit 105. The control circuits here control the rotational drive of the motor, the servo for the laser beam, and so forth.

When a recording and reproduction device constituted such as this is used, the magnetic disk of this embodiment has a recording layer with a structure having a stable state of bonding with hydrogen, and the recording and reproduction of information is possible while a tracking servo is actuated according to the surface shape or magnetically recorded pits.

With the magnetic disk of this embodiment, because the recording layer has a stable microstructure containing hydrogen, even when fine recording domains are recorded at high density, stable recording magnetic domains can be obtained.

The optical head here is shown disposed separate from and in the opposite direction from the magnetic head, but it is also possible to use a constitution in which irradiation is from the same side as the magnetic head, or a constitution in which the magnetic head is integral with the optical head or with a waveguide linked to a light source.

With the recording and reproduction device of this embodiment, even when fine magnetic domains are recorded and reproduced at high density, it is possible to achieve a recording and reproduction device that yields excellent recording and reproduction signal characteristics, with which stable recording domains can be formed and reproduction signals can be detected.

With the constitution of this embodiment, even when recording and reproduction are performed at high density, it is possible to achieve a magnetic recording medium with which stable recording magnetic domains can be formed, reproduction signal detection is excellent, and reliability is high, as well as a method for manufacturing this medium, and a recording and reproduction method.

Furthermore, with the recording layer in this embodiment, the manufacturing method described above involved sputtering in an atmosphere containing hydrogen in argon, krypton, or xenon, but a mixed inert gas containing one or more of neon, argon, krypton, and xenon may be used. As long as the hydrogen partial pressure here is from 0.2% to 20%, more preferably from 0.2% to 4%, to the film formation atmosphere may be a mixture with another gas. Also, the manufacturing method may be such that a magnetic recording film is formed while the amount of hydrogen (H₂) is varied during sputtering.

In the method for manufacturing a magnetic recording medium described above, hydrogen was taken up into the recording film by occlusion and adsorption by holding the disk in an argon atmosphere containing 20% hydrogen under a vacuum in a vacuum processing chamber, but the partial pressure may be 10% or higher if another gas such as nitrogen is used in an amount of at least 5% with respect to the argon. Also, the atmosphere in which the disk is held need not be a vacuum, and may instead be a pressurized atmosphere of 1 atm or higher. The conditions, such as the hydrogen content and partial pressure in the holding atmosphere, and the holding pressure and time, may be suitably set in this manufacturing method so that the hydrogen will be taken up into the recording film in a strongly bonded state.

In this embodiment, the manufacturing method described above involved adding hydrogen to the recording layer by etching a TbFeCo recording layer using an ion gun in an argon atmosphere containing at least 20 at % hydrogen, but it is also possible to subject the recording layer to dry etching such as ion irradiation etching whose irradiation ion includes hydrogen ion or plasma etching in an atmosphere in which the hydrogen partial pressure is from 0.2 to 20% with respect to the neon, argon, krypton, or xenon sputtering gas.

Also, in this embodiment, the manufacturing method described above involved evacuation to a high vacuum of 7×10⁻⁶ Pa or lower, and forming the film by introducing argon gas into a vacuum processing chamber of 2×10⁻⁸ Pa, but a similar effect will be obtained with a manufacturing method in which the recording layer is grown by introducing a sputtering gas into a vacuum processing chamber in which the ultimate vacuum prior to the formation of the recording layer is 5×10⁻⁵ Pa or lower and the hydrogen partial pressure in the evacuated state is at least 1×10⁻⁸ Pa. The hydrogen partial pressure in the vacuum processing chamber may be least 10 times the nitrogen partial pressure here.

With the method for manufacturing a recording layer in this embodiment, if the rotational speed of the disk substrate and the film formation rate are controlled during the formation of the TbFeCo recording layer, the microstructure of the Tb, Fe, and Co films can be changed, and a magnetic thin film having an amorphous film structure with large magnetic anisotropy may be used. More specifically, the above-mentioned film structure can be obtained by forming films of the various element particles at a rate of 0.5 nm/sec while at a rotational speed of 40 rpm during the formation of the TbFeCo recording layer.

After the formation of the recording layer, or after the formation of another thin film layer, etching may be performed to adjust to the desired surface roughness.

The constitution of the recording layer in this embodiment was described for a multilayer structure featuring magnetically induced super resolution, but a similar effect will be obtained with a constitution having a recording layer in which recording information is held. In this case, just one layer is used, or a recording layer and a reproduction layer are used for increasing the signal quantity of the reproduced information, and there may be magnetic exchange coupling between the two layers.

Also, a recording layer composed of TbFeCo was described above, but this may be a magnetic thin film made from an alloy of a rare earth metal and a transition metal, including one or more rare earth metals such as Tb, Gd, Dy, Nd, Ho, Pr, and Er, and a transition metal such as Fe, Co, or Ni.

Also, a reproduction layer of GdFeCoCr was described above, but this may instead be GdFeCoAl or another material composition, or a constitution in which materials of these are used, or a constitution comprising the lamination of multiple layers.

Alternatively, the constitution may be such that Tb and a transition metal (Fe, Co) are laminated in a periodic structure by controlling the rotational speed of the optical disk substrate and the film formation rate during the formation of the TbFeCo recording layer. If the laminar structure in this case is such that the lamination period is at maximum 2.0 nm or less, then it will be possible to increase Ms·Hc, which is the product of the saturation magnetization Ms and the coercive force Hc of the recording layer. Actually, with a recording layer having a 1.0 nm lamination period, a large Ms·Hc of 4.0×10⁻⁶ erg/cm² can be obtained, and even when tiny magnetic domains of 50 nm or smaller are recorded, stable recording magnetic domains can be formed, and even in repeated recording and reproduction, it will be possible to perform recording and reproduction with excellent signal characteristics.

A similar effect will be obtained if the recording layer of the magnetic recording medium of this embodiment has a constitution in which Th and Fe and Co are laminated at a period of at least 0.3 nm and no more than 4 nm, and the thickness of the recording layer is at least 20 nm, and preferably from 40 to 200 nm. There are no limitations on the periodic lamination structure of the Th and the transition metals (Fe, Co), and the constitution may be such that different targets are used for Tb, Fe, and Co, or other materials may be included, or the recording layer may have a lamination period of 2 nm or less.

In addition, the Curie temperature of the recording layer composed of TbFeCo was set between 300 and 350° C., but may be set to any temperature range over 150° C. according to the permissible range of environment temperature, the conditions of temperature elevation by the optical head, and the magnetic head characteristics.

The change in the magnetic characteristics of the magnetic recording medium here are also dependent on changes in the disk substrate or the base layer, and a comparable or better effect will be obtained by adjusting the coercive force, the saturation magnetization, the flux density, the magnetic anisotropy, the temperature characteristics of these, and so forth in the recording layer of the present invention.

Furthermore, a magnetic disk featuring magnetically induced super resolution and a DWDD system was described in this embodiment, and the film structure thereof was described as including a reproduction layer, an intermediate layer, a recording layer, and alternatively also a control layer, but the structure is not limited to this, and may instead be a magnetic recording medium with a film structure featuring magnetically induced super resolution and a RAD, FAD, CAD, or double mask system, or one in which the transferred magnetic domains are expanded and reproduced, such as a MAMMOS system. Furthermore, the structure of the recording film is not limited to a three-layer structure of a recording layer, an intermediate layer and a reproduction layer, or quad-layer structure, and may be a constitution in which a multilayer film having the necessary functions is formed.

In addition, a disk substrate on which pits of different surface roughness or bumps were formed was described for a magnetic recording medium featuring a DWDD system, but the constitution may instead be one that has grooves or lands to separate the recording tracks. Alternatively, guide grooves may be provided between tracks, and annealing performed. With a constitution such as this, one track in which information is recorded is magnetically isolated from the others, and the recording magnetic domains transferred to the reproduction layer readily undergo domain wall movement, so the resulting magnetic recording medium has even better DWDD signal characteristics. When the recording tracks are thus separated from one another by grooves or lands, tiny magnetic domains of 0.1 μm or smaller can be stably formed, good mobility of the transferred magnetic domain walls can be ensured with DWDD, and a magnetic disk with excellent reproduction signal characteristics can be obtained. Furthermore, cross write and cross talk from adjacent tracks can be reduced during recording and reproduction.

The material of the disk substrate described above was glass, an aluminum alloy metal, or polycarbonate, but other metal materials, plastic materials, or the like may be used instead.

Also, the magnetic disk of the above embodiments was described as having a constitution in which pits were formed by a photopolymer on the disk substrate surface, or a method such as imprinting was employed, but the pits may instead be worked by directly etching the disk substrate surface, or the pits may be directly worked, or the glass may be melted and the pits transferred. An alternative method is to use imprinting or the like to transfer to a photopolymer. With a disk substrate that utilizes surface roughness, a stamper produced by direct etching of a photoresist base may be used for transfer to the disk substrate, or a base surface formed on the disk substrate may be directly etched.

Another medium or manufacturing method that may be used is to form the recording layer on a disk substrate coated with self-organizing organic fine particles, which allows recording at a high density up to the size of the particle pattern. Further, recording at even higher density will be possible if the particles have uniform characteristics and a small diameter. Alternatively, the shape of self-organizing fine particles may be transferred onto the disk substrate. In particular, the same effect will be obtained when coating with fine particles, etching after transfer, or the like is performed.

Furthermore, a disk substrate having a track pitch of from 0.25 to 0.4 μm was described in this embodiment, but the width of the grooves in which information is recorded may be 0.6 μm or less, and the recording domains may have a minimum mark length of 0.3 μm for the recorded information. The effect will be better when the recording track and the linear recording density are smaller.

There are no restrictions on the depth and size of the prepits in this embodiment, but preferably the prepit depth is from 10 to 200 nm, and a comparable or better effect can be obtained with a constitution in which the prepits are as small as possible while still allowing signals from the prepits, such as servo pits or address pits, to be detected with a magnetic head.

The method described in this embodiment involved forming prepits of different surface shape, or prepits by magnetic recording, and detecting the address, but another method that may be used is to detect address information by wobbling grooves or lands. In this case, just one side of the grooves or lands can also be wobbled.

The constitution may also be such that a thermal absorption layer with a high coefficient of thermal conductivity is formed between the disk substrate and the dielectric under layer, and further forming a layer with a low coefficient of thermal conductivity so as to control the temperature distribution and thermal conduction within the disk.

The under layer was described above as being SiN, AlTiN, ZnS—SiO₂, TaO, or AgCu on the disk substrate, but it is also possible to use an oxide or nitride of AlTi, AlCr, Cr, Ti, Ta, or another material, or a II-VI or III-V family compound such as a chalcogen compound, or a metal material such as Al, Cu, Ag, Au, or Pt, or a mixed material containing one of these.

These materials may also be used as protective film materials.

The method described above was of further forming over the protective layer a solid lubricating layer composed of diamond-like carbon (DLC) by reactive RF sputtering using a carbon target in a mixed atmosphere of argon and CH₄, but if a DLC film is formed by CVD or the like, it will be possible to form an even more compact film.

In addition, a protective layer of amorphous carbon formed by sputtering was described above, but the present invention is not limited to this, so long as it is a material with a low surface roughness Ra, a small coefficient of friction, and high film strength.

Another method that may be used is to apply a film in a uniform thickness of about 5 μm by spin coating using an epoxy acrylate resin or a urethane resin, and cure this coating by irradiation with a UV lamp or with heat.

A constitution involving coating with a lubricating protective layer composed of a perfluoropolyether was described above, but spin coating, dipping, or another such method may be used. The lubricating layer may be a material that is stable on the underlying protective layer.

Also, the magnetic recording medium of the present invention may be further subjected to a step in which tape burnishing to remove any foreign matter, protrusions, or the like without scratching the surface, and afford a smooth coating with a uniform film thickness distribution from the inner periphery to the outer periphery.

Also, the disk substrate may be a double-sided type. In this case, servo pits must be formed on both sides, and recording layers and protective layers must also be formed on both sides. Also, with a recording and reproduction device, the drive structure must have a magnetic head attached on both sides. Furthermore, after the films are formed on both sides, the medium surface may be placed in a tape burnishing device and subjected to tape burnishing on both rotating sides from the inner periphery toward the outer periphery, so as to remove any foreign matter, protrusions, or the like.

As discussed above, with the magnetic recording medium of the present invention, there is provided at least a recording layer having magnetic anisotropy in the direction perpendicular to the film plane on a disk substrate, and the recording layer has a microstructure that has been stabilized by bonding with hydrogen, the result of which is that fine recording magnetic domains can be stably recorded, and a significant increase in recording density can be achieved without degrading the reproduction signal amplitude. Also, even with a recording medium that performs magnetic recording and reproduction while the temperature of the recording film rises under optical irradiation, servo characteristics will be stable, which enhances reliability and greatly improves disk productivity and cost.

Furthermore, it is possible to provide a magnetic recording medium with which stable recording and reproduction characteristics are obtained and signal characteristics are excellent, even when rewriting is repeatedly performed in high density recording, as well as a method for manufacturing this medium, and a recording and reproduction method.

### INDUSTRIAL APPLICABILITY

The magnetic recording medium of the present invention allows information to be recorded at high density, and is useful and can be applied as an information storage device and a memory medium.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

1. A magnetic recording medium comprising a recording film that includes at least a recording layer having magnetic anisotropy in the direction perpendicular to the film plane on a disk substrate;
wherein at least the recording layer contains elemental hydrogen in the film.

2. A magnetic recording medium comprising a recording film that includes at least a recording layer having magnetic anisotropy in the direction perpendicular to the film plane on a disk substrate;
wherein the recording layer contains a hydrogen compound.

3. The magnetic recording medium according to claim 1, wherein the hydrogen uptake into the recording layer is localized.

4. The magnetic recording medium according to claim 1, wherein the elemental hydrogen taken up into the recording layer is in a bonded state with a thermal desorption (TDS) temperature of at least 500° C.

5. The magnetic recording medium according to claim 1, wherein the recording film includes a rare earth metal; and
the hydrogen in the recording film is in a state of localized bonding with the rare earth metal in the recording film.

6. The magnetic recording medium according to claim 5, wherein the rare earth metal is at least one selected from among Tb, Gd, Dy, Nd, Ho, Pr, and Er.

7. The magnetic recording medium according to claim 1, wherein the recording layer forms a columnar structure.

8. The magnetic recording medium according to claim 1, wherein the recording layer forms a superlattice-like laminar structure.

9. The magnetic recording medium according to claim 1, wherein the hydrogen atom uptake of the recording layer is at least 0.2 at %.

10. The magnetic recording medium according to claim 1, wherein the recording film is made up of a plurality of layers; and
the hydrogen content in the recording layer is the greatest out of the plurality of layers.

11. The magnetic recording medium according to claim 1, wherein the thickness of the recording layer is at least 20 nm and no more than 400 nm.

12. The magnetic recording medium according to claim 1, wherein the recording film includes an intermediate layer, and
the thickness of the intermediate layer is at least 5 nm.

13. A method for manufacturing a magnetic recording medium, comprising the step of forming on a disk substrate at least a recording layer having magnetic anisotropy in the direction perpendicular to the film plane;
wherein the recording layer is grown using a vacuum atmosphere in which the ultimate vacuum in a vacuum processing chamber at least prior to the formation of the recording layer is no higher than 5×10⁻⁵ Pa, and the hydrogen gas partial pressure in a vacuum evacuated state is at least 1×10⁻⁸ Pa.

14. The method for manufacturing a magnetic recording medium according to claim 13, wherein the hydrogen partial pressure in the vacuum processing chamber is at least 10 times the nitrogen partial pressure.

15. A method for manufacturing a magnetic recording medium, comprising the step of forming on a disk substrate at least a recording layer having magnetic anisotropy in the direction perpendicular to the film plane;
wherein the recording layer is grown as a film in an atmosphere containing hydrogen at least during the formation of the recording layer.

16. The method for manufacturing a magnetic recording medium according to claim 15, wherein the hydrogen partial pressure is between 0.2% and 20% with respect to a sputtering gas containing neon, argon, krypton, or xenon.

17. The method for manufacturing a magnetic recording medium according to claim 15, further comprising the step of forming an under layer that serves as a base for the recording layer at a deposition rate is lower than the deposition rate during the formation of the recording layer.

18. The method for manufacturing a magnetic recording medium according to claim 15, wherein the recording layer is formed at a film deposition rate of at least 2 nm/sec and no higher than 20 nm/sec.

19. A method for manufacturing a magnetic recording medium, comprising:
forming on a disk substrate at least a recording layer having magnetic anisotropy in the direction perpendicular to the film plane; and
holding the magnetic recording medium in an atmosphere containing hydrogen at least after the formation of the recording layer.

20. The method for manufacturing a magnetic recording medium according to claim 19, wherein the magnetic recording medium is held in a vacuum atmosphere containing argon, and the hydrogen partial pressure with respect to the argon in the vacuum is at least 5%.

21. The method for manufacturing a magnetic recording medium according to claim 19, wherein the magnetic recording medium is held in an atmosphere that contains hydrogen and has been pressurized to at least 1 atm.

22. The method for manufacturing a magnetic recording medium according to claim 19, wherein the magnetic recording medium is held in an atmosphere in which the hydrogen partial pressure with respect to nitrogen is at least 10%.

23. A method for manufacturing a magnetic recording medium comprising:
forming on a disk substrate at least a recording layer having magnetic anisotropy in the direction perpendicular to the film plane; and
performing ion irradiation etching, plasma etching, or another type of dry etching in an atmosphere containing hydrogen gas at least after the formation of the recording layer.

24. The method for manufacturing a magnetic recording medium according to claim 23, wherein the hydrogen partial pressure is between 0.2% and 20% with respect to a sputtering gas containing neon, argon, krypton, or xenon.

25. A method for manufacturing a magnetic recording medium, comprising the step of forming on a disk substrate at least a recording layer having magnetic anisotropy in the direction perpendicular to the film plane;
wherein the ultimate vacuum in a vacuum processing chamber in which the recording layer is to be formed is no higher than 5×10⁻⁵ Pa at least prior to the formation of the recording layer, and the hydrogen gas partial pressure in a vacuum evacuated state is at least 1×10⁻⁸ Pa.

26. A method for manufacturing a magnetic recording medium, comprising the step of forming on a disk substrate at least a recording layer having magnetic anisotropy in the direction perpendicular to the film plane;
wherein the recording layer is grown as a film in an atmosphere containing hydrogen at least during the formation of the recording layer.

27. A method for manufacturing a magnetic recording medium, comprising:
forming on a disk substrate at least a recording layer having magnetic anisotropy in the direction perpendicular to the film plane; and
holding the magnetic recording medium in an atmosphere containing hydrogen at least after the formation of the recording layer.

28. A method for manufacturing a magnetic recording medium in, comprising:
forming on a disk substrate at least a recording layer having magnetic anisotropy in the direction perpendicular to the film plane;
performing ion irradiation etching, plasma etching, or another type of dry etching in an atmosphere containing hydrogen gas at least after the formation of the recording layer.

29. (canceled)

30. A method of recording and reproducing with a magnetic recording medium, comprising the step of recording and reproducing information signals on a disk while the temperature of the recording layer is raised by directing a laser spot at a magnetic recording medium according to claim 1.

31. A method of recording and reproducing with a magnetic recording medium, comprising the step of recording and reproducing information signals on a disk while the temperature of the recording layer is raised by directing a laser spot at a magnetic recording medium according to claim 2.

32. A method of recording and reproducing with a magnetic recording medium, comprising the step of recording and reproducing information signals on a disk while the temperature of the recording layer is raised by directing a laser spot at a magnetic recording medium manufactured by the manufacturing method according to claim 13.

33. A method of recording and reproducing with a magnetic recording medium, comprising the step of recording and reproducing information signals on a disk while the temperature of the recording layer is raised by directing a laser spot at a magnetic recording medium manufactured by the manufacturing method according to claim 15.

34. A method of recording and reproducing with a magnetic recording medium, comprising the step of recording and reproducing information signals on a disk while the temperature of the recording layer is raised by directing a laser spot at a magnetic recording medium manufactured by the manufacturing method according to claim 19.

35. A method of recording and reproducing with a magnetic recording medium, comprising the step of recording and reproducing information signals on a disk while the temperature of the recording layer is raised by directing a laser spot at a magnetic recording medium manufactured by the manufacturing method according to claim 23.

36. A method of recording and reproducing with a magnetic recording medium, comprising the step of recording and reproducing information signals on a disk while the temperature of the recording layer is raised by directing a laser spot at a magnetic recording medium according to claim 25.

37. A method of recording and reproducing with a magnetic recording medium, comprising the step of recording and reproducing information signals on a disk while the temperature of the recording layer is raised by directing a laser spot at a magnetic recording medium according to claim 26.

38. A method of recording and reproducing with a magnetic recording medium, comprising the step of recording and reproducing information signals on a disk while the temperature of the recording layer is raised by directing a laser spot at a magnetic recording medium according to claim 27.

39. A method of recording and reproducing with a magnetic recording medium, comprising the step of recording and reproducing information signals on a disk while the temperature of the recording layer is raised by directing a laser spot at a magnetic recording medium according to claim 28.
